(19) United States
(12) Patent Application Publication
(10) Pub. No.: US 2002/0128029 A1
(43) Pub. Date: Sep. 12, 2002

(54) Data distribution device and method, and data receiving device and method

(76) Inventors: Shoji Nishikawa, Tokyo (JP); Hirotsugu Yamamoto, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 10/036,454

(22) Filed: Jan. 7, 2002

(30) Foreign Application Priority Data
Jan. 10, 2001 (JP) 2001-002997
Dec. 21, 2001 (JP) 2001-390398

(51) Int. Cl. H04Q 7/20

(52) U.S. Cl. 455/517; 455/466

(57) ABSTRACT

It is an object of this invention to correct a receiving error of a data stream in a set-top box when a software program is distributed by using data broadcasting. A base station converts a software program into a data stream of DSM-CC data carousel type, divides the data stream into transport packets of MPEG-2 type, and distributes the software program to the set-top box via a communications satellite. If the set-top box detects any receiving error of the data stream, it requests the base station to resend the transport packet which has not been properly received. The base station then resends the requested transport packet to the set-top box via a public circuit.

### BACKGROUND OF THE INVENTION

1. Field of the Invention

This invention relates to a technique to correct receiving errors in connectionless, one-way data distribution.

2. Description of the Related Art

As digital satellite broadcasting services have spread in recent years, content application distribution services of such as videos and voices have been increasing. In such environment, there is a need for constructing a communication system in which massive amounts of data, such as game software, can be sent and received faster and more accurately.

Japanese Patent Publication No. 2000-115047 discloses a technique to distribute game software by using digital satellite broadcasting. The system adopts an asymmetrical routing protocol in which uplink is realized by a standard dial-up line and downlink is realized by a high-speed satellite line. In the same system, when a user makes a request to download game software, the request reaches a satellite broadcasting device through the dial-up line. The satellite broadcasting device then verifies the user and returns user information including a start time and an ending time of the data broadcasting.

The satellite broadcasting device multiplexes game software program data, modulates the multiplexed data to an intermediate frequency with a modulator, converts the frequency to microwaves by using an up-converter, amplifies the microwaves by using a power amplifier, and then transmits the amplified microwaves to a communications satellite via a parabolic antenna. A data stream is transmitted from a transponder of the communications satellite to a receiving device on the ground. The use of a large capacity high-speed line for the satellite broadcasting allows the high-speed, simultaneous distribution of massive amounts of contents, such as game programs, to the receiving devices.

The data stream transmitted from the communications satellite to the receiving device includes encapsulated transport packets of Moving Picture Experts Group Phase 2 (MPEG-2). When a content is distributed via the satellite line, some transport packets are sometimes not properly received due to the effects of, for example, changes in the atmospheric density, the generation of ducts, or rainfall.

In such case, if the content of, for example, a film is to be distributed, pictures may be displayed flickering only for a moment and no large problems will occur in viewing the film. However, in the case of a software program such as game software, the game program cannot be run if any part of the transport packets is not received properly.

Accordingly, in order to have the receiving device receive the entire data properly, it is necessary to take some measures to compensate for receiving errors in the connectionless, one-way data distribution such as satellite broadcasting. This is not limited to the distribution of software programs, but also applies to the distribution of video data and audio data.

Various cable networks (ground networks) such as an ISDN network, a packet communications network, an IP network and ATM network are more reliable than a satellite line since their error rates of data transmission are extremely low. However, when it comes to the distribution of software programs, a receiving error of even one data bit is not acceptable. Therefore, even if the software program is distributed via such cable network, it is still necessary to enhance reliability of the data distribution.

Moreover, when a user's receiving device connected to a network has an old version of the game software stored thereon, no consideration has conventionally been given to automatically updating the game software to the latest version.

Furthermore, when a conventional set-top box, which has received an electronic program guide with a distribution date and time of game software described therein, displays a reception reservation guide screen, it does not distinguish the game software which has not been received from the game software which has already been received. Accordingly, there is an inconvenience that the user has to check whether the game software included in the electronic program guide has already been received or not. It is also inconvenient in that when the received game software is being updated, no consideration is given to informing the user of such updating.

It is a first object of this invention to provide a data distribution device and method, and a data receiving device and method for correcting any receiving errors of a data stream when the data stream is broadcasted.

It is a second object of this invention to provide a software program distribution device and method, and software program receiving device and method for automatically updating software programs owned by a user by using the data broadcasting.

It is a third object of this invention to provide a data receiving device, a selection screen displaying method, and a reception reservation guide information display screen which are highly convenient for the user.

### SUMMARY OF THE INVENTION

In order to achieve the first object, this invention receives, from a receiving device having received a data stream composed of a plurality of transmission units and broadcasted by a broadcasting transmission system, a request to resend the data stream of some transmission units; and resends the data stream of the transmission units via a two-way communication line. Accordingly, a data stream which was not properly received by the receiving device due to the effects of changes in the atmospheric density, the generation of ducts, and rainfall, can be received on an individual transmission unit basis, via the two-way communication line. Thereby, the receiving errors can be corrected.

According to another aspect of this invention, it receives, from a receiving device which has received a data stream composed of a plurality of transmission units and broadcasted via a cable network, a request to resend the data stream of some transmission units, and resends the data stream of the transmission units via a two-way cable network.

In order to achieve the second object, this invention receives software program update information broadcasted in one direction by a broadcasting transmission system using a ground wave or a satellite wave; compares software program update information which has been already received with software program update information which has been broadcasted; requests a data distribution device via a two-way communication line to download a software program corresponding to the broadcasted update information when it is necessary to update the software program already received; and downloads the software program via the two-way communication line. Accordingly, the receiving device can download a software program which needs to be updated, on the basis of the update information broadcasted.

According to still another aspect, this invention receives software program update information broadcasted in one direction via a cable network; compares software program update information which has been already received with software program update information which has been broadcasted; requests a data distribution device via a two-way cable network to download a software program corresponding to the broadcasted update information when it is necessary to update the software program already received; and downloads the software program via the two-way cable network.

In order to achieve the third object, when a selection screen of a received content which has been broadcasted in one direction by a broadcasting transmission system is displayed by means of a ground wave or a satellite wave, and if data relating to the content to be updated is being received, this invention performs display processing to display the selection screen of the content to be updated in a different manner from the selection screen of the other received contents.

Moreover, this invention receives content distribution guide information broadcasted in one direction by a broadcasting transmission system using ground waves or satellite waves, and if a content contained in the distribution guide information includes any unreceived content, this invention displays a reception reservation guide screen by distinguishing the unreceived content from the received content.

According to still another aspect, when a selection screen of a received content which has been broadcasted in one direction via a cable network is displayed, and if data relating to a content to be updated is being received, this invention performs display processing to display the selection screen of the content to be updated in a different manner from the selection screen of the other received contents.

According to a still further aspect, this invention receives content distribution guide information broadcasted in one direction via a cable network; and if a content contained in the distribution guide information includes any unreceived content, displays a reception reservation guide screen by distinguishing the unreceived content from the received content.

### BRIEF DESCRIPTION OF THE DRAWINGS

FIG. 1 is a block diagram of an entire digital satellite broadcasting system.

FIG. 2 is a circuit block diagram of a set-top box and a game device.

FIG. 3 is an explanatory diagram illustrative of a transmission format of a carousel type.

FIG. 4 is an explanatory diagram illustrative of a transport packet.

FIG. 5 is a diagram illustrative of communications between the set-top box and the respective servers.

FIG. 6 is an explanatory diagram illustrative of an electronic program guide.

FIG. 7 is a flowchart of reception reservation processing.

FIG. 8 is a flowchart of reception reservation processing.

FIG. 9 is a flowchart of error correction processing.

FIG. 10 is a flowchart of reception confirmation processing.

FIG. 11 is a flowchart of packet-receiving-processing.

FIG. 12 is an explanatory diagram illustrative of a reception history table.

FIG. 13 is an explanatory diagram illustrative of a game selection screen.

FIG. 14 is an explanatory diagram illustrative of a data distribution system using a cable network.

FIG. 15 is an explanatory diagram illustrative of a data distribution system using a cable network.

### DESCRIPTION OF THE PREFERRED EMBODIMENTS

An embodiment of the present invention will be hereinafter explained with reference to the attached drawings.

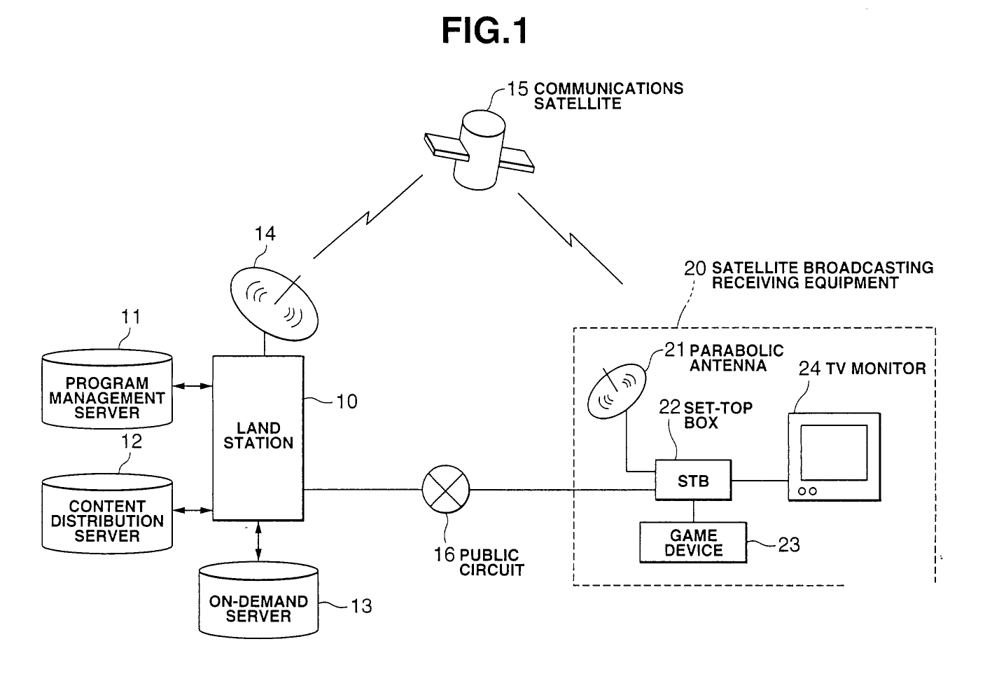

FIG. 1 is an entire block diagram of a digital satellite broadcasting system. The digital satellite broadcasting system shown in FIG. 1 is composed of uplink from a satellite broadcasting receiving equipment 20 through a public circuit 16 to a land station 10, and downlink from the land station 10 through a communications satellite 15 to the satellite broadcasting receiving equipment 20. The uplink allows two-way communications, enabling data transmission by connection type communications using the Transmission Control Protocol (TCP) for a transport layer and the Internet Protocol (IP) for a network layer. The downlink allows one-way data broadcasting communications via the satellite line, using the User Datagram Protocol (UDP) for the transport layer and the IP for the network layer. This digital satellite broadcasting system also uses an Asynchronous Transfer Mode (ATM) in a wireless zone as a protocol for a data link layer.

A program management server 11 is a server for managing a content distributed from the land station 10 through the communications satellite 15 to the satellite broadcasting receiving equipment 20. The program management server 11 prepares an electronic program guide (EPG) for indicating, for example, distribution dates and times of game software, introductions of games, and the times required to download the game software. A content distribution server 12 is a server for distributing to the satellite broadcasting receiving equipment 20 program contents in which images and sounds are integrated, as well as software programs such as game software for video games. The content data is written in the Multimedia and Hypermedia information coding Experts Group (MHEG) format.

In this embodiment, an explanation is given about a case in which the Digital Storage Media-Command and Control (DSM-CC) type is used as a protocol for distributing contents of data broadcasting services. The DCM-CC method provides a controlling method for taking out MPEG coding bit streams accumulated in a digital storage medium via a network or for accumulating bit streams in accumulating media. The DCM-CC method is standardized to MPEG-2-6 (ISO/IEC 18138-6).

An on-demand server 13 sends to individual users at their request via the public circuit 16 transport packets which the satellite broadcasting receiving equipment 20 could not properly receive, when data is distributed to several tens of thousands of households via the satellite line. Examples of the public circuit 16 include various ground lines such as telephone line networks, ISDN networks, Internet networks, and dedicated lines. The public circuit 16 allows two-way communications. The two-way communication line is not limited to a cable line, but it can be a wireless network. The land station 10 multiplexes the electronic program guide prepared by the program management server 11 and various contents in MHEG format supplied by the content distribution server 12, modulates the multiplexed guide and contents to intermediate frequencies by using a modulator, further converts the intermediate frequencies to microwaves by using an up-converter, amplifies the microwaves with a power amplifier, and then transmits the amplified microwaves to the communications satellite 15 via a parabolic antenna 14.

The communications satellite 15 has a plurality of transponders mounted thereon, so that it performs low-noise amplification of a data stream uplinked from the land station 10, converts the data stream to the frequencies for downlinking, then performs power amplification, distributes the obtained frequencies to the satellite broadcasting receiving equipment 20 at the transmitting speed of several tens of Mbps. The satellite broadcasting receiving equipment 20 is composed of a parabolic antenna 21, a set-top box 22, a game device 23, and a TV monitor 24. Radio waves radiated from the uplink site via the transponders of the communications satellite 15 include various packet data of images, sounds, and other data. These radio waves reach the parabolic antenna 21 located on the ground, and weak radio waves are subjected to low-noise amplification with a Low Noise Block down converter (LNB) and are also subjected to down-conversion to an intermediate frequency band, and the obtained radio waves are then supplied to the set-top box 22.

The set-top box 22 conducts Quadrature Phase Shift Keying (QPSK) demodulation, error correction, deinterleave processing, decoding processing, and other processing of the received signals, outputs video and audio data constituting program contents to the TV monitor 24, and stores software programs such as game programs on an internal hard disk. The electronic program guide and various program contents are displayed on the TV monitor 24. The game device 23 is a home game-only machine and it is structured to be capable of reading the game program stored in the set-top box 22 and of conducting game processing. Information about the number of times the game was played and the time spent playing the game is sent to the land station 10 via the public circuit 16 and charging processing is conducted. The game device 23 and the set-top box 22 may be integrally structured.

Next, a data stream distribution procedure by the DSM-CC method will be explained. In the DSM-CC method, a unit for sending and receiving data is called a module. A module corresponds to a subdirectory, a file, a stream, and a stream event which are included in a route directory corresponding to one data broadcasting service. A subdirectory is a folder for compiling data which relate to one another. A file is a data file of, for example, static images, sounds, texts, and scripts written in the MHEG format. A stream includes information which links to other data services and AV streams. A stream event includes linking information and time information.

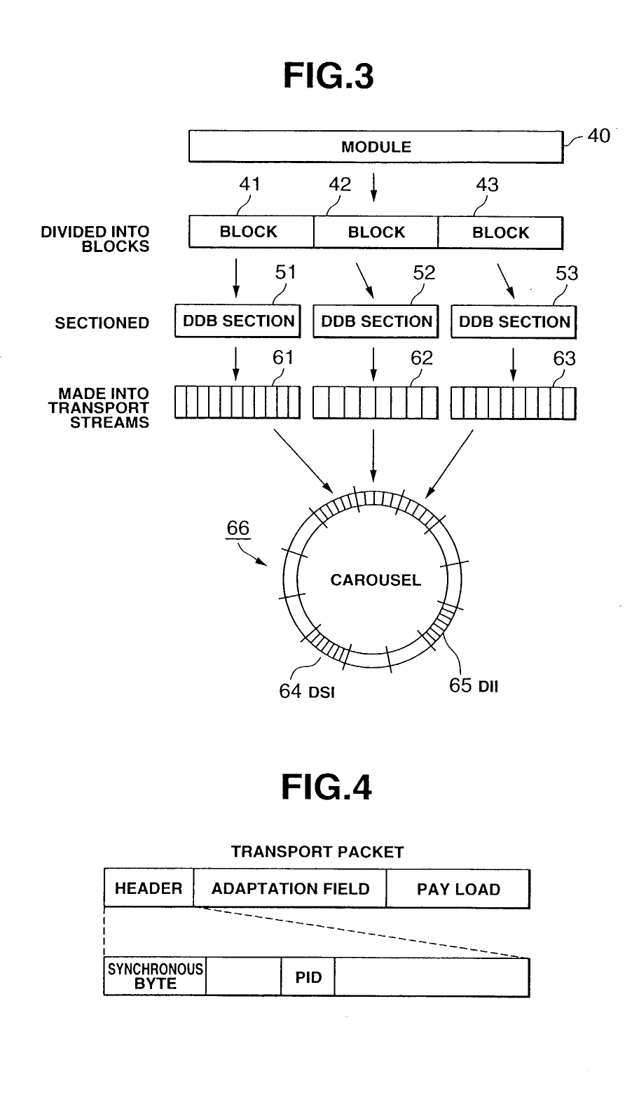

In the DSM-CC method, data is converted into a section form which is a transmission form of MPEG-2. The size of a section is limited to 4 KB on the basis of the MPEG-2 standard. As shown in FIG. 3, a module 40 is mechanically divided into blocks 41 to 43. A DSM-CC header is added to each divided block 41 to 43 and the blocks are converted into a structure called DDB. A header and a Cyclic Redundancy Check Code (CRC) are further added to each DDB, which is then made into a section form which is one transmission form of MPEG-2, thereby forming a section. Thus, DDB sections 51 to 53 are generated from all the modules constituting one data broadcasting service.

As control information necessary for receiving the DDB sections properly, two download control messages are prepared in the DSM-CC method: Download Indication Information (DII) and Download Server Initiate (DSI). DII and DSI are the information necessary for receiving modules from received data at the set-top box 22. DSI is mainly a module identifier, and includes information about the entire carousel (for example, the time required for one rotation of the carousel, and a time-out value of rotations of the carousel). DSI also has information to make it aware of the locations of data services route directories. DII is the information corresponding to the respective modules included in the carousel, including information on, for example, sizes, versions, and time-out values of each module.

DII and DSI have headers and CRCs added thereto as does DDB, and are converted respectively into section forms called a DII section and a DSI section. The DDB section, DII section and DSI section are converted into MPEG-2 transport streams 61 to 65, are pasted onto a surface of a virtual rotating body called a carousel, and are then transmitted sequentially in accordance with the rotations of a carousel 66.

As shown in FIG. 4, a MPEG-2 transport stream is structured by coupling transport packets of a fixed length of 188 bytes. Each transport packet is configured by a header, an adaptation field, and a payload. In the header, for example, a synchronous byte, Packet Identify (PID), scramble control information, and adaptation field control information are arranged. PID is packet identification information and is used for identifying types of, for example, video data, audio data, and game software program data.

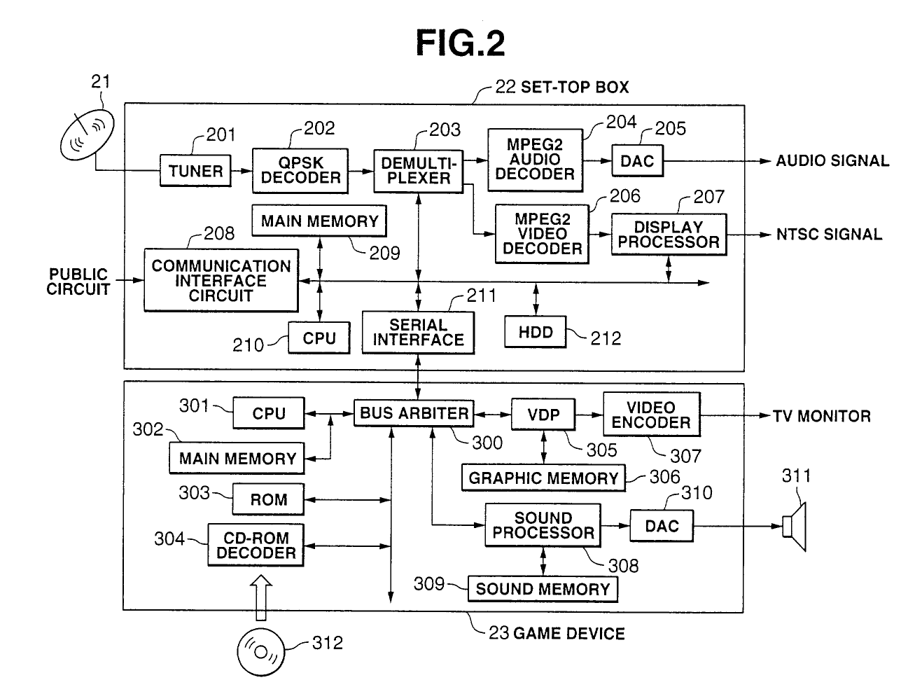

FIG. 2 is a block diagram of the set-top box 22 and the game device 23. Signals received from the communications satellite by the parabolic antenna 21 are supplied to a tuner 201 and are then converted to base band signals. These base band signals are subjected to QPSK demodulation with a QPSK decoder 202, and are further subjected to demodulation processing and correction processing, thereby reconstructing a transport stream. A demultiplexer 203 refers to, for example, PID of a transport packet and separates the transport stream into, for example, video data, audio data, game software program data, and MHEG data.

The audio data extracted from the transport packet is supplied to an MPEG-2 audio decoder 204 and is then subjected to decoding processing. Subsequently, the audio data is converted into analog signals by a DAC 205, which are then output on the TV monitor 24 as audio signals. The video data is supplied to an MPEG-2 video decoder 206 and is then subjected to the decode processing. Subsequently, the video data is supplied to a display processor 207. The MHEG data is first accumulated in a main memory 209, and is then subjected to the decode processing by a CPU 210. The MHEG data is then converted to video data in order to provide a Graphical User Interface (GUI) screen on the TV monitor 24 in accordance with a script written in the MGEG data. This video data is supplied to the display processor 207. The display processor 207 conducts encode processing of the video data supplied from the MPEG-2 audio decoder 204 and the CPU 210, and it converts the video data into luminance signals of the NTSC type, chrome signals, and composite signals.

On the other hand, the program data of the game software extracted from the transport packet is transferred from the demultiplexer 203 to a hard disk 212, and is stored on the hard disk. The set-top box 22 comprises a communication interface circuit 208 inside so that it can transfer the program data of the game software sent from the on-demand server via the public circuit to the hard disk 212, and store the transferred program data on the hard disk 212. The program data of the game software stored on the hard disk 212 is structured in such a manner that it can be transferred to the game device 23 via a serial interface 211.

The game device 23 is a home game-only machine and is structured such that it can transfer the game program data stored on the hard disk 212 of the set-top box 22 to the main memory 302 via a bus arbiter 300 and conduct the game processing with the CPU 301. If the game program is distributed from the land station 10 in the form of a load module, the load module stored in the hard disk 212 is transferred to the main memory 302 by a loader and it becomes an execution module. The load module is made by establishing links, by means of a linkage editor, between object modules, which are made by compiling source programs created by programmers per every compile unit, and object modules which are previously registered in a program library for every subroutine.

A ROM 303 has, for example, a system initialization program stored therein. When the power is turned on, the CPU 301 executes the system initialization program from the ROM 303, and conducts the initialization of the entire device. Moreover, the CPU 301 can read the game program data recorded in the CD-ROM 312, which is inserted into a CD-ROM drive 304, and then conduct the game processing.

In the game processing, the CPU 301 transfers video data to a graphic memory 306 and also transfers audio data to a sound memory 309. A video display processor 305 reads necessary data for image display from the video data stored in the graphic memory 306, and conducts, for example, coordinate conversion, texture mapping processing, display priority processing, and shading processing on the basis of a plotting command, visual point position data, light source position data, object designation data, texture designation data, visual field conversion matrix data, and other data which are supplied from the CPU 301. The video encoder 307 converts the video data generated by the video display processor 305 into television signals of NTSC type and outputs them on the TV monitor 24.

The sound processor 308 reads the data, such as voice waves, stored in the sound memory 309 in accordance with a command supplied from the CPU 301, and it conducts various effects processing on the basis of a Digital Signal Processor (DSP) function. The DAC 310 converts the audio data generated by the sound processor 308 into analog signals and outputs then to a speaker 311.

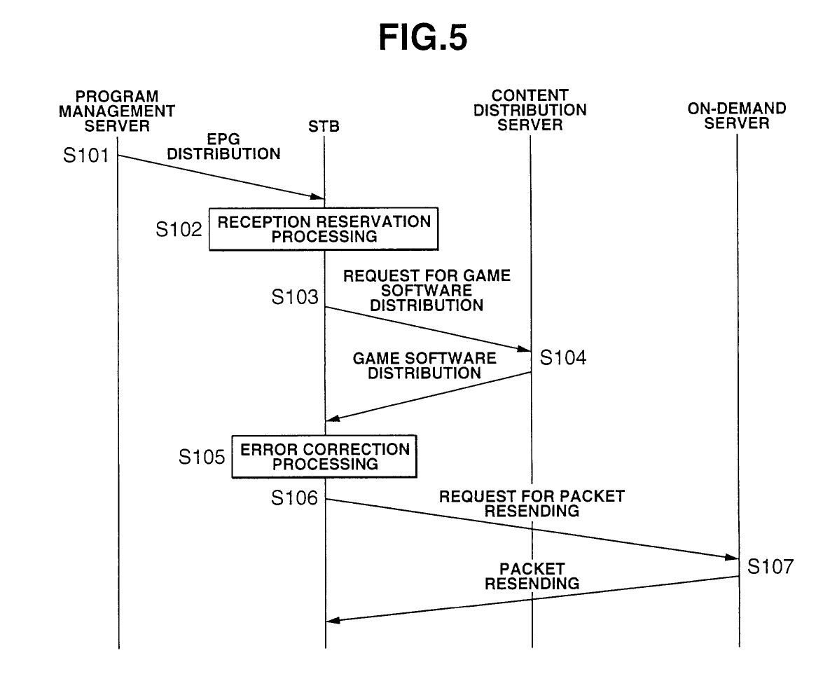

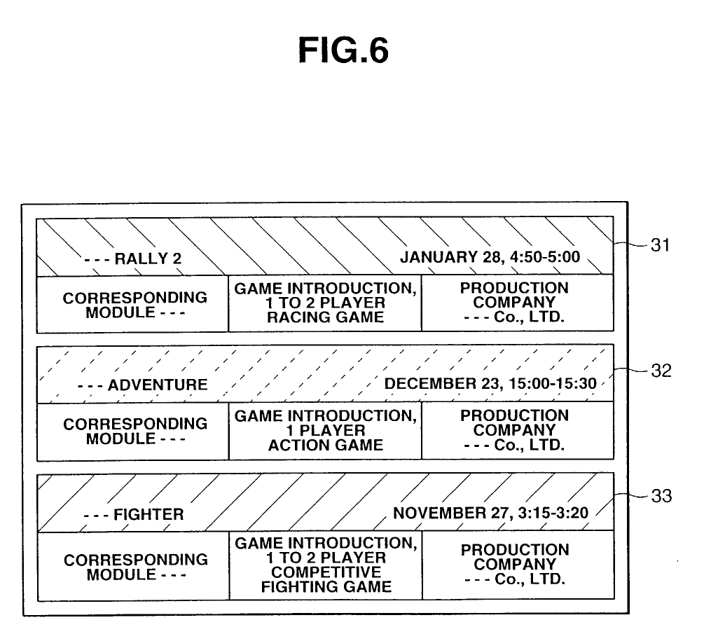

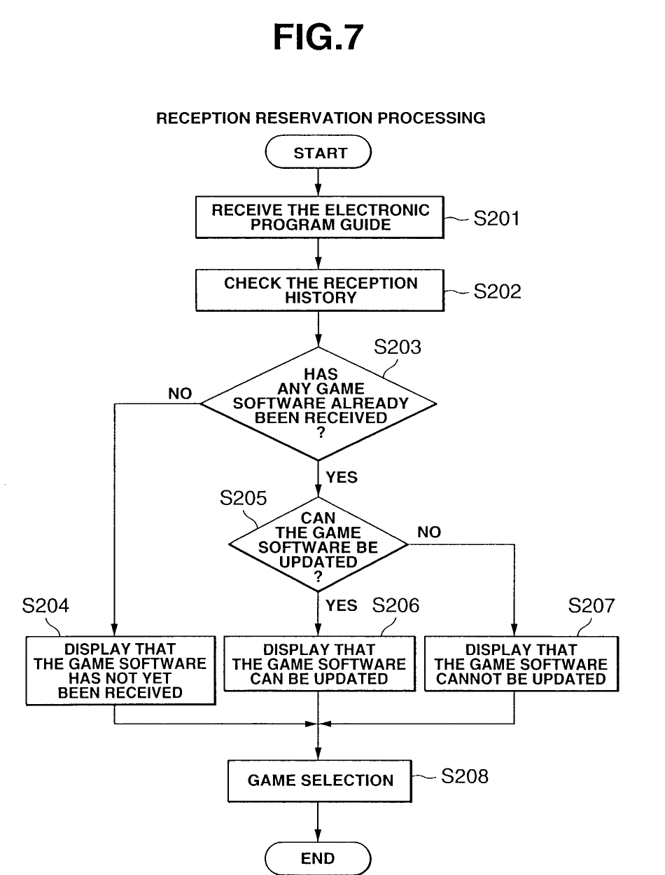

Next, a procedure of simultaneous distribution of a game program to individual households by using the satellite line will be hereinafter explained with reference to FIG. 5. In FIG. 5, a program management server 11 distributes to the set-top box 22 an electronic program guide for indicating distribution dates and times of game software (step S101). As shown in FIG. 6, the electronic program guide describes game titles, distribution dates and times, corresponding modules, game instructions, and production companies. When the set-top box 22 receives the electronic program guide, it conducts reception reservation processing for a game software program (step S102) This preprogram processing is conducted in accordance with the processing procedure shown in FIG. 7. Firstly, when the electronic program guide is received (step S201), the set-top box 22 checks reception histories of the game software (step S202).

If any game software which has not yet been received is included in the game software listed in the electronic program guide (step S203; NO), it is indicated that there is game software which has not yet been received (step S204). For this denotation, a game title is displayed, for example, in red as shown with the reference numeral 31 in FIG. 6, in order to inform a user that the game software with the title displayed in red has not yet been received. On the other hand, if any game software which has already been received is included in the game software listed in the electronic program guide (step S203; YES), the set-top box 22 refers to game software update information distributed with the electronic program guide from the program management server 11 as well as update information of the game software stored in the hard disk 212, and checks whether or not the game software stored in the hard disk 212 can be updated (step S205).

The update information refers to the information about updated contents of game programs. It includes, for example, version information relating to extensions of the game programs (for example, designations in game titles such as “- - - 2”, “- - - 3”, “- - - version 2.1”, or “- - - version 2.2”), as well as information concerning debugging processing when there is any bug in the game programs. If the game software can be updated (step S205; YES), it is indicated that the game software can be updated (step S206). For this denotation, a game title is displayed, for example, in green as shown with reference numeral 33 in FIG. 6, in order to inform the user that the game software can be updated. On the contrary, if the game software cannot be updated (step S205; NO), it is indicated that the game software cannot be updated (step S207). For this denotation, a game title is displayed, for example, in blue as shown with reference numeral 32 in FIG. 6, in order to inform the user that the game software cannot be updated.

As explained above, by changing the display color of a game title in the GUI screen, the user can judge visually whether or not the game software has already been received. And if the game software has already been received, the user can also judge by the color whether it can be updated or not. When the user selects game software to receive by referring to the GUI screen (step S208), the reception reservation processing is completed.

In the above explanation, a red color display is used when the game software has not yet been received, and a green color display is used when the game software has already been received and can be updated, and a blue color display is used when the game software has already been received but cannot be updated. However, without limitation to the above examples, a combination of the colors can be set freely. Moreover, in the above explanation, the example is shown in the case of changing the color displays of the game titles. However, any measures such as text display, image display, or voice guidance, can also be used as long as such measures can be used to inform the user of whether game software has been received or not and whether an update can be conducted or not. Moreover, when an update can be conducted, it is also possible to change the display manner for the case in which version updating is possible and for the case in which debug processing is possible. For example, when version updating can be conducted, a game title is displayed in green and text is also displayed to the effect that version updating can be conducted (for example, “Version updating possible”). When the debug processing can be conducted, the game title is displayed in green and a text is also displayed to the effect that the debug processing can be conducted (for example, “Debug processing possible”).

Methods for updating a game program include:

1. newly sending an entire updated game program;

2. sending a modification program for interchanging subroutines at the time of version updating or debugging; and

3. when the game program is composed of plural files, sending only the files necessary to be modified for the version updating or debugging, and overwriting a hard disk 212 at the set-top box 22.

Thus, the previously stored data and the updated data are stored in association with each other.

In the above explanation, the display color of the game title is changed in order to urge the user to update the game software when the game software has already been received and can be updated. However, such a structure may be employed that the game software is forcefully updated by having the set-top box 22 automatically reserve the reception of the game software. With this structure, the user can always enjoy the latest version game software or the debugged game software.

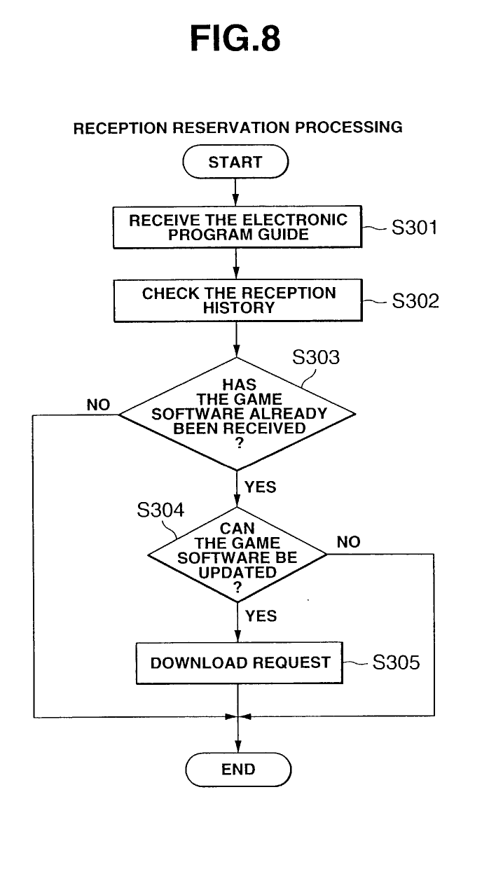

FIG. 8 shows a flowchart of the reception reservation processing in the above case. The set-top box 22 receives the electronic program guide distributed from the program management server 11 (step S301), and then checks the reception history of the game software (step S302). If there is any game software which has been received (step S303; YES) and can be updated (step S304; YES), the set-top box 22 requests a content distribution server 12 to download the game software (step S305). If there is no game software received (step S303; NO) or if the game software cannot be updated (step S304; NO), the set-top box 22 does not request the downloading of the game software.

If the reception preprogramming of the game software is completed, the set-top box 22 requests the content distribution server 12 to distribute the game software (step S103). When it is the date and time to distribute the game software, the game software is distributed from the content distribution server 12 (step S104). For the distribution of the game software, as described above, the data stream of the software program is distributed on a transport packet unit basis. There may be some cases in which some transport packets are not properly received due to the effects of, for example, changes in the atmospheric density, generation of ducts, and rainfalls. Therefore, when some transport packets have not been properly received, error correction processing is conducted (step S105).

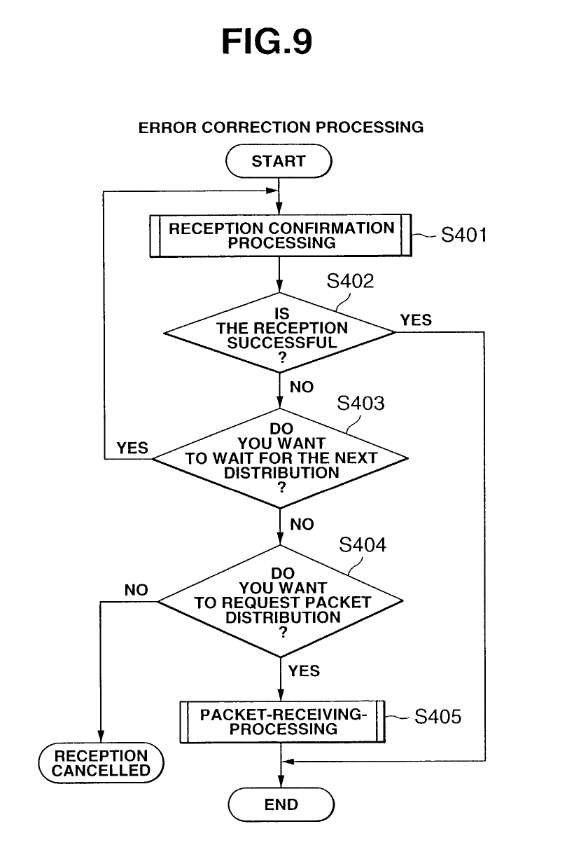

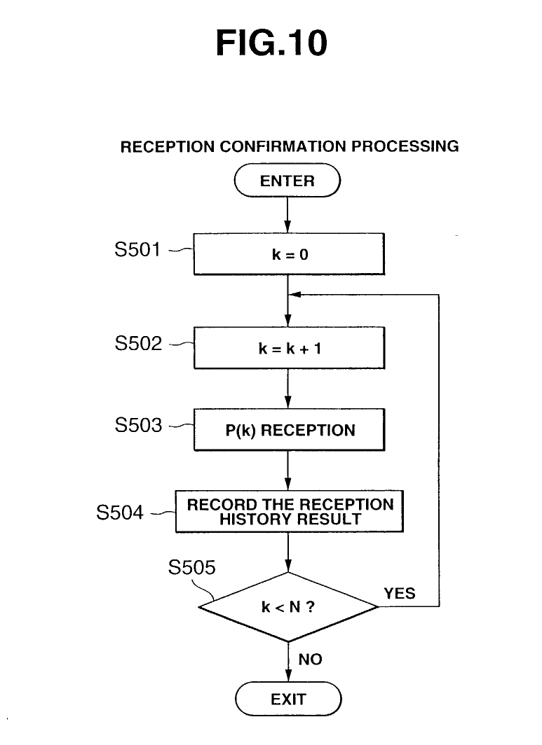

The error correction processing procedure will be explained with reference to FIG. 9. The set-top box 22 conducts processing to check whether individual transport packets distributed from the content distribution server 12 have been properly received or not (step S401: reception confirmation processing). FIG. 10 is a flowchart of the subroutine for the reception confirmation processing. In this flowchart, N is the number of the transport packets distributed from the content distribution server 12, and P(i) is an ith transport packet. A variable k, which is the variable for counting the number of the received transport packets, is initialized to 0 (step S501), and is then incremented by one (step S502).

Next, when a kth transport packet P(k) is received (step S503), the reception history of P (k) is recorded in a specified memory region (step S504). The reception history of the transport packet is, for example, as shown in FIG. 12. In this example, P(1) and P(2) are successfully received, P(3) is not properly received, and P(N) is received successfully. The set-top box 22 judges whether P(k) has been properly received or not by referring to DSI, DII, and PID mentioned above. Accordingly, the set-top box 22 records the reception history of each transport packet (step S505).

Now returning to the explanation of the main flowchart of FIG. 9, if all the transport packets have been received (step S402; YES), reception of the game software is completed. On the other hand, if any of the transport packets has not been properly received (step S402; NO), the set-top box 22 requires the user to choose whether he/she waits for the next game software distribution or not (step S403). If the user gives instructions to wait for the next game software distribution (step S403; YES), the set-top box 22 waits for the next distribution, and when the time comes to receive the game software, the set-top box 22 again conducts the processing following step S401.

On the other hand, if the user chooses not to wait for the next game software distribution (step S403; NO), the set-top box 22 requires the user to choose whether he/she makes a request for resending the transport packet which was not properly received (step S404). If the user does not make such request (step S404; NO), the receiving processing ceases. If the user makes such request (step S404; YES), the set-top box 22 requests an on-demand server 13 to resend the transport packet, and conducts the receiving processing of the transport packet (step S405: packet-receiving-processing).

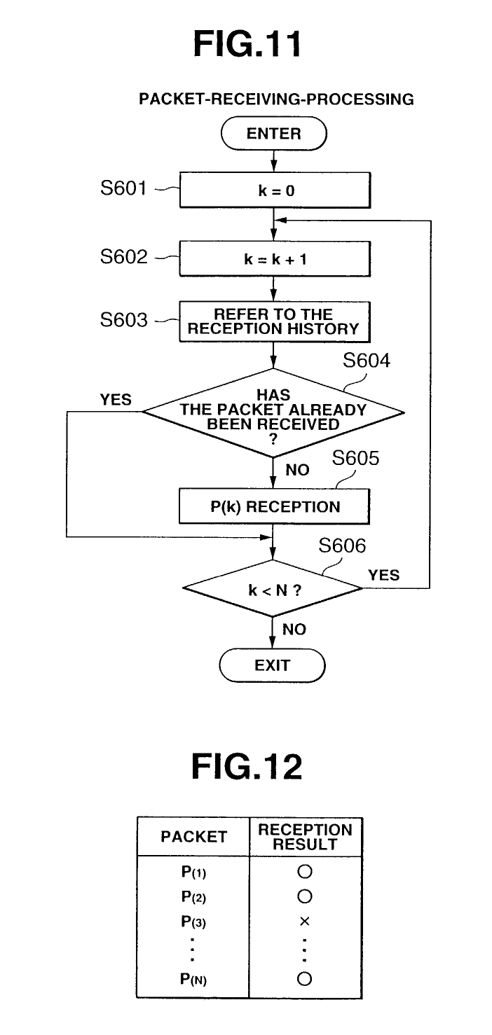

While the content distribution server 12 distributes the game software simultaneously to several tens of thousands of households via the satellite line, the on-demand server 13 resends the transport packet to each household via the public circuit 16 on the ground. FIG. 11 is a flowchart of a subroutine of the packet-receiving-processing by the set-top box 22. The packet-receiving-processing is conducted on the demand of the set-top box 22 (on-demand processing). In the packet-receiving-processing, the variable k is first initialized to 0 (step S601), and the value of the variable k is incremented by one (step S602). Next, the set-top box 22 checks whether a packet was properly received or not by referring to the reception history of P(k) shown in FIG. 12 (step S603). If the packet was not properly received (step S604; NO), the set-top box 22 receives P(k) (step S605) and returns to step S602. On the other hand, if the packet was properly received (step S604; YES), the set-top box 22 skips the receiving processing of P(k) and returns to step S602.

Through the above-mentioned steps, the transport packets resent from the land station 10 via the public circuit 16 are stored in the set-top box 22. The hard disk 212 stores the game software programs broadcasted via the satellite line and received properly, such that the programs individually resent in order to compensate for the receiving errors are incorporated therein, i.e., in a load module state. The storage state of the game software stored in the hard disk 212 is not limited the above-described state, but the game software programs can also be stored in the state in which the game software programs broadcasted via the satellite line and received properly, and the programs individually resent in order to correct the receiving errors, have headers respectively added thereto, which include information to establish a link between these two types of programs. In this case, when the game software is transferred to the main memory 302 by a loader, the headers are referred to and the above-described two types of programs are linked, thereby forming an execution module.

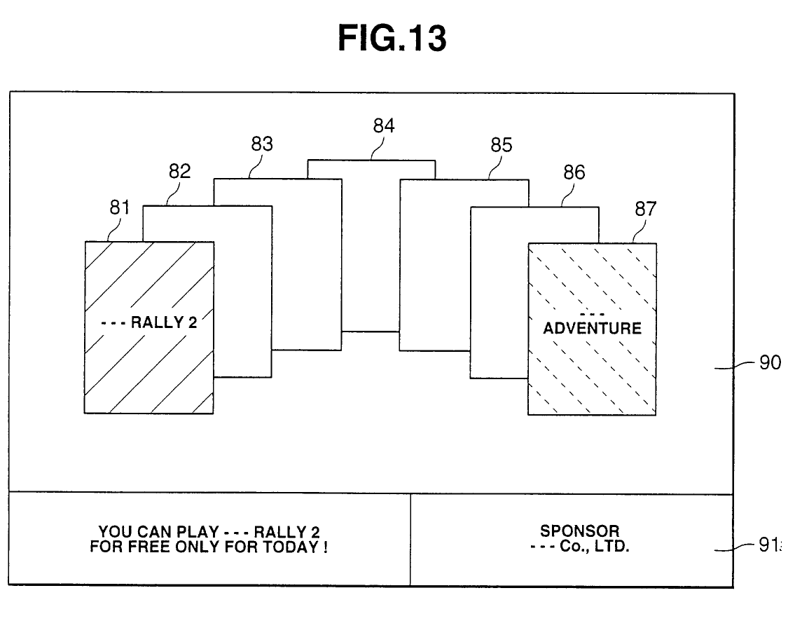

FIG. 13 is a screen display allowing the user to choose a game from the game software stored in the set-top box 22. In FIG. 13, title displays 81 to 87 of the game software stored in the set-top box 22 are placed in an upper part 90 of the screen. Moreover, a sponsor advertisement is displayed in a bottom part 91 of the screen. The user can choose a game from the title displays 81 to 87 of the game software. However, if the game software is being updated for version updating or debugging at the user's request, the user is informed that the game software is being updated by the change in the color of the title display of the relevant game software from that of the other title displays as shown with reference numeral 81. For example, if game software called “- - - Rally 2” is being updated, the color of the game title display 81 is changed to red and the other game title displays are shown in yellow. In addition to informing the user of the update by changing, for example, the color when the game software is being updated, it is also possible to limit the game choices so that the game software being updated cannot be executed.

If the game software is automatically updated by the set-top box 22, it is possible to inform the user of the automatic update by changing the color of the title display of the game software being updated from that of the other title displays. For example, if the game software called “- - - Adventure” is being updated automatically, the game title display 87 is shown in blue. Accordingly, the update of the game software can be indicated visually, and therefore effectively. Moreover, in some cases, it may not be desirable that the user is informed of the update, such as when the game software is being automatically updated for the debugging processing of the game program. Therefore, the title display does not necessarily have to be changed.

When the user selects a game from the screen shown in FIG. 13 and executes it, billing information about the playing time and so on is sent to the land station 10 via the public circuit 16. Examples of the billing method for the game play include: flat rate billing such as 1000 Yen per month, or setting the playing time for a specified rate (for example, 500 Yen for 3 nights and 4 days, 800 Yen for 7 nights and 8 days, or 100 Yen for 3 minutes) and charging extra fees (for example, 1000 Yen for 30 minutes) when the game was played beyond the playing time which was set in advance. It is also possible to employ another billing method of charging the user for playing a pay stage appearing in the game scenario (for example, 400 Yen for one stage). Moreover, it is possible to charge the user for each item which his/her character obtains in a role-playing game. When the game playing time is limited within a specified fee, the remaining playing time can be indicated on the TV monitor 24. Moreover, if the game software is sponsored, such a structure may be employed that the user can play the game for free for a specified period of time (for example, only for today) Such settings may be made to discount the fee on the basis of points (scores) of the game result. As for the settlement processing, payment can be made by using a credit card, electronic money, or through a bank account.

According to this invention, massive amounts of game software can be distributed to many households efficiently and accurately, by combining the connectionless-type, one-way, wide area broadcasting processing of the game software by using the satellite line, and the connection-type, individual resending processing of the transport packets by using the two-way communication line. Moreover, even if the game software has already been received, the game software can be automatically updated or debugged via the network. Therefore, the user can always enjoy the latest game version, or the debugged game.

In the example explained above, when some transport packets are not properly received, the set-top box 22 requests the on-demand server 13 to resend the transport packets or the set-top box 22 waits for the next distribution date and time of the game software. However, without limitation to such examples, such structure may be employed that plural channels are set to have different transmission speeds for data streams of the satellite line, and a channel having low bit rate is selected when a transport packet was not properly received.

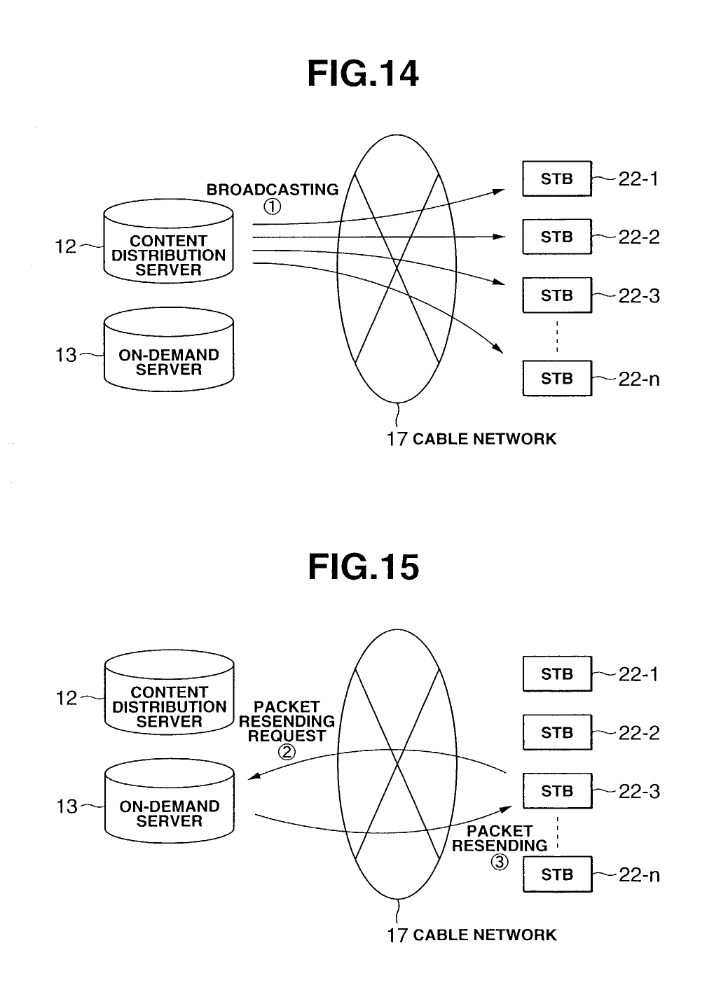

The software program may be distributed from the content distribution server 12 or the on-demand server 13 to the set-top box 22, not only through the wireless network using the ground waves or the satellite waves, but also through a cable network. FIG. 14 shows a network connection configuration in a case in which data is distributed to the set-top boxes 22 belonging to a certain group, by using IP multicast. Various IP networks, such as LANs, WANs, ATM networks, Open Computer Networks (OCN), CATV networks, and Internet networks, can be used as a cable network 17 as long as the network allows data duplication only for necessary addresses by a router for passing on packets, and the data distribution to the set-top boxes 22 belonging to a certain group.

FIG. 14 shows how data is broadcasted from the content distribution server 12 to n set-top boxes, 22-1, 22-2, 22-3, . . . 22-n, belonging to a certain group (\mathring{1}). If even a transmission error of one bit is not allowable as in the case of broadcasting software program, it is desirable to use the Reliable Multicast Transport Protocol (RMTP) as a file transport protocol for one to multiplicity.

Assuming that a data transmission error has occurred in the set-top box 22-3, the set-top box 22-3 requests the on-demand server 13 to resend the transport packet in which the receiving error has occurred (\mathring{2}). Then, the on-demand server 13 resends the transport packet required to the set-top box 22-3 (\mathring{3}). Specifically, the correction of the data transmission error is conducted by the unicast of one to one.

The above explanation is about the case in which the game software is distributed to household satellite broadcasting receiving equipment. However, this invention is not limited to the above example, but can be applied to the distribution of game software to amusement facilities such as amusement arcades. Moreover, the broadcasting transmission system of game software programs is not limited to the DSM-CC method, and an arbitrary transmission protocol can be used. Furthermore, a content subject to the data distribution is not limited to game software, but may include video data or audio data. The data broadcasting can be conducted using wireless networks such as the Communications Satellite (CS), the Broadcasting Satellite (BS), or the ground waves, as well as the cable networks of various IP networks such a LANs, WANs, ATM networks, OCNs, CATV networks, and Internet networks.

Moreover, a terminal device for downloading game software from the content distribution server 12 and receiving a transport packet in which a receiving error has occurred from the on-demand server 13 is not limited to the set-top box, but may also be a mobile terminal such as a cellular phone, a Personal Handyphone System (PHS), or a Personal Digital Assistants (PDA) which have packet data communications functions.

According to this invention, the data stream which was not properly received by the receiving device due to the effect of, for example, changes in the atmosphere density, generation of ducts, and rainfall, can be received on an individual transmission unit basis via the two-way communication line, thereby making it possible to correct the receiving errors. Moreover, it is possible to correct, without fail, the transmission errors of the data stream which have passed through the cable network. Furthermore, according to this invention, the receiving device can update the software program as necessary. This invention can also provide a data receiving device, a selection screen display method, and a reception reservation guide screen display method, which are extremely convenient for the user.

What is claimed is:

1. A data distribution device comprising:
resending request responding means for receiving, from a receiving device having received a data stream composed of a plurality of transmission units and broadcasted by a broadcasting transmission system, a request to resend the data stream of some transmission units; and
resending means for resending the data stream of the transmission units via a two-way communication line.

2. A data distribution method of receiving, from a receiving device having received a data stream composed of a plurality of transmission units and broadcasted by a broadcasting transmission system, a request to resend the data stream of some transmission units, and resending the data stream of the transmission units via a two-way communication line.

3. A data distribution device comprising:
resending request responding means for receiving, from a receiving device having received a data stream composed of a plurality of transmission units and broadcasted via a cable network, a request to resend the data stream of some transmission units; and
resending means for resending the data stream of the transmission units via a two-way cable network.

4. A data distribution method of receiving, from a receiving device having received a data stream composed of a plurality of transmission units and broadcasted via a cable network, a request to resend the data stream of some transmission units, and resending the data stream of the transmission units via a two-way cable network.

5. A data receiving device for receiving data broadcast broadcasted in one direction by means of a ground wave or a satellite wave, comprising:
receiving means for receiving a data stream composed of a plurality of transmission units appropriate for a specified broadcasting transmission system;
resending requesting means for requesting a data distribution device via a two-way communication line to resend any data stream of the transmission units which has not been properly received, and for receiving the data stream of the transmission units via the two-way communication line.

6. The data receiving device according to claim 5, further comprising storing means for storing any properly received data among the broadcasted data, and any data received via the two-way communication line among the data which was not properly received, by establishing associations between these data.

7. A data receiving method of receiving data broadcast broadcasted in one direction by means of a ground wave or a satellite wave, comprising the steps of:
receiving a data stream composed of a plurality of transmission units appropriate for a specified broadcasting transmission system;
requesting a data distribution device via a two-way communication line to resend any data stream of transmission units, which has not been properly received; and
re-receiving the data stream of the transmission units via the two-way communication line.

8. The data receiving method according to claim 7, further comprising a step of storing any properly received data among the broadcasted data, and any data received via the two-way communication line among the data which was not properly received, by establishing associations between these data.

9. A data receiving device for receiving a data stream broadcasted in one direction via a cable network, comprising:
receiving means for receiving a data stream composed of a plurality of transmission units; and
resending requesting means for requesting a data distribution device via a two-way cable network to resend any data stream of transmission units which has not been properly received, and for receiving the data stream of the transmission units via the two-way cable communication network.

10. The data receiving device according to claim 9, further comprising storing means for storing any properly received data among the broadcasted data, and any data received via the two-way communication line among the data which was not properly received, by establishing associations between these data.

11. A receiving method of receiving a data stream broadcasted in one direction via a cable network, comprising the steps of:
receiving a data stream composed of a plurality of transmission units;
requesting a data distribution device via a two-way cable network to resend any data stream of transmission units which has not been properly received; and
re-receiving the data stream of the transmission units via the two-way cable communication network.

12. The data receiving method according to claim 11, further comprising the step of storing any properly received data among the broadcasted data, and any data received via the two-way communication line among the data which was not properly received, by establishing associations between these data.

13. A data distribution system comprising:
broadcasting means for converting content data to a data stream appropriate for a specified broadcasting transmission system, dividing the data stream into a plurality of transmission units, and broadcasting the content data. to a plurality of receiving devices in one direction by the broadcasting transmission system; and
resending means for resending any data stream of transmission units which has not been properly received by the receiving device, to the receiving device via a two-way communication line if a resending request of the data stream is made from the receiving device via the two-way communication line.

14. The data distribution system according to claim 13, wherein the broadcasting means adjusts a transmission bit rate of the data stream according to a wireless environment.

15. A data distribution method comprising the steps of:
converting content data to a data stream appropriate for a specified broadcasting transmission system;
dividing the data stream into a plurality of transmission units, and broadcasting the content data to a plurality of receiving devices in one direction by the broadcasting transmission system; and
resending any data stream of transmission units which has not been properly received by the receiving device, to the receiving device via a two-way communication line if a resending request of the data stream is made from the receiving device via the two-way communication line.

16. The data distribution method according to claim 15, further comprising the step of adjusting a transmission bit rate of the data stream broadcasted to the receiving device, according to a wireless environment.

17. A data distribution system comprising:
broadcasting means for converting content data to a data stream appropriate for a specified broadcasting transmission system, dividing the data stream into a plurality of transmission units, and broadcasting the content data to a plurality of receiving devices in one direction via a cable network; and
resending means for resending any data stream of transmission units which has not been properly received by the receiving device, to the receiving device via a two-way cable network if a resending request of the data stream is made from the receiving device via the two-way cable network.

18. A data distribution method comprising the steps of:
converting content data to a data stream appropriate for a specified broadcasting transmission system;
dividing the data stream into a plurality of transmission units, and broadcasting the content data to a plurality of receiving devices in one direction via a cable network; and
resending any data stream of transmission units which has not been properly received by the receiving device, to the receiving device via a two-way cable network if a resending request of the data stream is made from the receiving device via the two-way cable network.

19. A software program distribution device comprising:
receiving means for receiving a software download request from a receiving device having received software program update information broadcasted by a broadcasting transmission system; and
distribution means for distributing a software program corresponding to the update information to the receiving device via a two-way communication line.

20. A software program distribution method comprising the steps of:
receiving a software download request from a receiving device having received software program update information broadcasted by a broadcasting transmission system; and
distributing a software program corresponding to the update information to the receiving device via a two-way communication line.

21. A software program distribution device comprising:
receiving means for receiving a software download request from a receiving device having received software program update information broadcasted via a cable network; and
distribution means for distributing a software program corresponding to the update information to the receiving device via a two-way cable network.

22. A software program distribution method comprising the steps of:
receiving a software download request from a receiving device having received software program update information broadcasted via a cable network; and
distributing a software program corresponding to the update information to the receiving device via a two-way cable network.

23. A software program receiving device comprising:
receiving means for receiving software program update information broadcasted in one direction by a broadcasting transmission system using a ground wave or a satellite wave; and
downloading means for comparing the software program update information which has been already received, with software program update information which has been broadcasted, and requesting, via a two-way communication line, a data distribution device to download a software program corresponding to the broadcasted update information if it is necessary to update the software program already received, and downloading the software program via the two-way communication line.

24. A software program receiving method comprising the steps of:
receiving software program update information broadcasted in one direction by a broadcasting transmission system using a ground wave or a satellite wave;
comparing the software program update information which has been already received, with software program update information which has been broadcasted;
requesting, via a two-way communication line, a data distribution device to download a software program corresponding to the broadcasted update information if it is necessary to update the software program already received; and
downloading the software program via the two-way communication line.

25. A software program receiving device comprising:
receiving means for receiving software program update information broadcasted in one direction via a cable network; and
downloading means for comparing the software program update information which has been already received, with software program update information which has been broadcasted, and requesting, via a two-way cable network, a data distribution device to download a software program corresponding to the broadcasted update information if it is necessary to update the software program already received, and downloading the software program via the two-way cable network.

26. A software program receiving method comprising the steps of:
receiving software program update information broadcasted in one direction via a cable network;
comparing the software program update information which has been already received, with software program update information which has been broadcasted;
requesting, via a two-way cable network, a data distribution device to download a software program corresponding to the broadcasted update information if it is necessary to update the software program already received; and
downloading the software program via the two-way cable network.

27. The data distribution device according to claim 1 or 3, wherein the data stream broadcasted to the receiving device is a software program converted into a specified transmission system.

28. The data distribution method according to any one of claims 4, 15, 16, and 18, wherein the data stream broadcasted to the receiving device is a software program converted into a specified transmission system.

29. The data receiving device according any one of claims 5, 6, 9, and 10, wherein the data stream broadcasted to the receiving device is a software program converted into a specified transmission system.

30. The data receiving method according to any one of claims 7, 8, 11, and 12, wherein the data stream broadcasted to the receiving device is a software program converted into a specified transmission system.

31. The data distribution system according to any one of claims 13, 14, and 17, wherein the data stream broadcasted to the receiving device is a software program converted into a specified transmission system.

32. A data receiving device comprising:
receiving means for receiving a content broadcasted in one direction by a broadcasting transmission system using a ground wave or a satellite wave; and
display means for displaying a selection screen of the received content,
wherein, the data receiving device comprises display means for performing display processing to display a selection screen of the content to be updated in a different manner from a selection screen of the other received content while receiving data regarding the content to be updated.

33. A selection screen displaying method for displaying, at the time of displaying a selection screen of a received content which has been broadcasted in one direction by a broadcasting transmission system by means of a ground wave or a satellite wave, a selection screen of the content to be updated in a different manner from a selection screen of the other received content while receiving data regarding the content to be updated.

34. A data receiving device comprising:
receiving means for receiving a content broadcasted in one direction via a cable network; and
display means for displaying a selection screen of the received content,
wherein, the data receiving device comprises display means for performing display processing to display a selection screen of the content to be updated in a different manner from a selection screen of the other received content while receiving data regarding the content to be updated.

35. A selection screen displaying method for displaying, at the time of displaying a selection screen of a received content which has been broadcasted in one direction via a cable network, a selection screen of the content to be updated in a different manner from a selection screen of the other received content while receiving data regarding the content to be updated.

36. A data receiving device comprising:
receiving means for receiving content distribution guide information broadcasted in one direction by a broadcasting transmission system using a ground wave or a satellite wave; and
display means for displaying a reception reservation guide screen by distinguishing any unreceived content from the received content if the content contained in the distribution guide information includes any unreceived content.

37. A reception reservation guide screen displaying method comprising the steps of:
receiving content distribution guide information broadcasted in one direction by a broadcasting transmission system using a ground wave or a satellite wave; and
displaying a reception reservation guide screen by distinguishing any unreceived content from the received content if the content contained in the distribution guide information includes any unreceived content.

38. A data receiving device comprising:
receiving means for receiving content distribution guide information broadcasted in one direction via a cable network; and
display means for displaying, a reception reservation guide screen by distinguishing any unreceived content from the received content if the content contained in the distribution guide information includes any unreceived content.

39. A reception reservation guide screen displaying method comprising the steps of:
receiving content distribution guide information broadcasted in one direction via a cable network; and
displaying a reception reservation guide screen by distinguishing any unreceived content from the received content if the content contained in the distribution guide information includes any unreceived content.
